(19) United States
(12) Patent Application Publication
(10) Pub. No.: US 2005/0208382 A1
(43) Pub. Date: Sep. 22, 2005

(54) COMPOSITE WIRE HAVING IMPERVIOUS CORE FOR USE IN AN ENERGY STORAGE DEVICE

(75) Inventors: Ajoy Datta, Fullerton, CA (US); Benny E. Jay, Austin, TX (US)

Correspondence Address: SNELL & WILMER;ONE ARIZONA CENTER, 400 EAST VAN BUREN, PHOENIX, AZ, 850040001, US

(73) Assignee: EAGLEPICHER HORIZON BATTERIES, LLC, Phoenix, AZ (US)

(21) Appl. No.: 10/907,077

(22) Filed: Mar. 18, 2005

Related U.S. Application Data
(60) Provisional application No. 60/554,677, filed on Mar. 19, 2004.
(60) Provisional application No. 60/618,727, filed on Oct. 14, 2004.

(51) Int. Cl. H01M 4/74; H01M 4/66; H01M 4/68

(52) U.S. Cl. 429/238; 429/241; 429/234; 429/245

(57) ABSTRACT

A current collector for use in an energy storage device, particularly a lead-acid battery or lead-carbon capacitor, is provided. The current collector is woven from a plurality of weft composite wires and a plurality of warp composite wires. The composite wires include a core and a metal coating formed around the outer surface of the core. The core includes a plurality of longitudinally extending fibers radially arranged to define interstices between outer surfaces of adjacent fibers, and a matrix positioned within the interstices to such an extent that the core is substantially impervious to fluid (e.g., acid) penetration via capillary forces.

### CROSS REFERENCE TO RELATED APPLICATIONS

This application claims priority to U.S. Provisional Application No. 60/554,677 filed Mar. 19, 2004, and U.S. Provisional Application No. 60/618,727, filed Oct. 14, 2004, which provisional applications, in their entirety, are hereby incorporated by reference.

### FIELD OF INVENTION

The present invention generally relates to the field of batteries and capacitors, such as lead-acid batteries and lead-carbon capacitors, which use current collectors comprised of composite wires including an impervious core coated with a layer of metal. In particular, the impervious core includes a fibrous material disposed in a matrix that renders the core substantially impervious to fluid penetration by capillary forces.

### BACKGROUND OF THE INVENTION

The use of lead-acid batteries as energy storage devices is well known in the art. Lead-acid batteries are secondary batteries, in that they can be discharged and charged throughout many cycles, thus making them a preferred energy storage device in systems that require a high capacity battery capable of multiple charge/discharge cycles. One major drawback of a lead-acid battery is, however, its weight, which results from the significant amount of lead used in the battery plates or grids that carry the electrochemically active materials. The significant weight of a lead-acid battery accounts for its low energy to weight ratio.

Strides have been made in attempts to reduce the weight of lead-acid batteries to increase the energy to weight ratio. For example, U.S. Pat. No. 4,658,623 (hereinafter, the '623 patent) discloses a battery grid, also known as an electrode current collector, made of a composite wire and its method of manufacture. The composite wire of the '623 patent is produced by extruding a coating/sheath of lead onto a core material. The core material can be a single fiber or multiple fibers, but is preferably composed of multiple fibers to achieve sufficient tensile strength to allow the wire to survive the extrusion process, as well as other subsequent manufacturing steps. The multiple fiber construction further provides for a large surface area between the core material and the metal to provide a robust interface for connecting the core and sheath materials and also increases the overall strength of the current collector during use.

In the manufacturing process disclosed in the '623 patent, lead balls are heated in a conduit and dropped into a chamber. A plunger moves the lead balls through an aperture into a compression chamber, where the lead is further heated to a predetermined temperature to soften the lead to an extrudable state. A hydraulic cylinder is then actuated to cause a piston to descend into the compression chamber and force the lead out of the chamber and into a space between an entry die and an exit die. The multi-fiber core material is passed through the entry and exit dies where it is coated with lead by the extrusion process to create the composite wire.

FIG. 1 shows an example of a composite wire resulting from the process disclosed in the '623 patent. The composite wire includes a multi-fiber core material 1 having a coating of lead 2 formed there around by the extrusion process. The inventors of the '623 patent recognized that only the outer surface of the composite wire had to be composed of lead to function as a material for making a current collector. Based on this recognition, the inventors of the '623 patent made the inner portion of the composite wire using a significantly lighter material, such as fiberglass, which thus reduced the overall weight of the battery significantly.

The composite wire disclosed in the '623 patent is used to form current collectors, such as shown in FIG. 2. A plurality of composite wires is woven to create a current collector 10. The current collector includes a plurality of warp composite wires 11 and a plurality of weft composite wires 12.

The current collector 10 shown in FIG. 2 may be used for both positive and negative grids in a battery. In both instances, a layer of active material is applied and forced into the spaces between the woven composite wires. When cured, the latticework of the grid retains the active material and creates an electrode of increased durability and conductivity and exceptionally uniform potential distribution. The electrode is also substantially lighter in weight, due to the use of the composite wire.

The composite wire disclosed in the '623 patent is particularly well adapted for use in bipolar electrodes. In bipolar electrodes positive and negative half-cells share the same current collector, such as disclosed in U.S. Pat. No. 4,964,878 (hereinafter, the '878 patent). U.S. '878 discloses a woven current collector (grid), such as that shown in FIG. 2, formed by a composite wire such as disclosed in the '623 patent. Positive and negative active materials are positioned on the same grid, but spaced from one another to form a biplate 20, such as is shown in FIG. 3. The biplate 20 includes weft composite wires 21, for example, to provide electrical connection between the positive 22 and negative 23 sides of each biplate 20. A plurality of biplates are created in this manner, and then stacked in a battery case 30, such as is shown in FIG. 4. Half biplates 31, known also as monopolar plates, also are used as necessary to complete the battery. Separators 32 are positioned between adjacent biplates 20, in a manner well known in the art. The battery is then flooded with an appropriate electrolyte and charged to electrochemically form the appropriate energy-storage compounds on the battery plates, as also is well known in the art.

The contributions provided to the field of lead-acid batteries by the inventors of the '623 and the '878 patents have been significant. The present inventors have discovered, however, that the unique structure of the composite wire creates an area of self-discharge within the battery that degrades the overall efficiency of the battery. Before explaining this discovery, it will be helpful to first understand the basic electrochemical process that occurs in a lead-acid battery and the inherent inefficiencies associated with that process.

In a lead-acid battery, certain lead-bearing compounds contained in the materials on the positive and negative plates of a cell are converted electrochemically via reduction-oxidation charge-exchange reactions to energy-storage compounds. During the discharge cycle, ionic transport between the positive and negative plates of the cell through the electrolyte enables electron flow from the negative terminal to the positive terminal of the battery through an external load. This charge transfer process between the active materials on the negative and positive plates of the cell oxidizes the lead in the negative plate and reduces the lead in the positive plate in such a manner that the potential difference between the charged plates moves toward zero. In a secondary battery, this electrochemical reaction is reversible. By means of a charger, the charge flow may be reversed. When the charger voltage is properly controlled, it supplies to the battery terminals electrons capable of reducing the discharged lead in the negative plate and oxidizing the lead in the positive plate. By such means, electrons are stored in the cell and the original charged state of the battery is restored.

During the discharge cycle of a lead-acid battery cell, lead (Pb) on the negative plate loses two electrons, becomes a positively charged ion soluble in aqueous solution where it reacts with sulfate (SO₄²⁻) from the electrolyte solution to from PbSO₄, and eventually precipitates out of solution as a solid salt. This reaction supplies electrons through the external circuit required to support the electrochemical reaction on the positive plate, in which the +4 valence state of lead in PbO₂ is reduced by two electrons supplied from the negative plate, becomes a Pb²⁺ ion soluble in the electrolyte, where it reacts with the SO₄²⁻ ion in the electrolyte solution to produce PbSO₄ and eventually precipitates out of solution as the salt PbSO₄. These discharge process reactions are shown below for the lead-acid battery:

Negative Plate:
Pb⁰+SO₄²⁻→PbSO₄+2e⁻

Positive Plate:
PbO₂+SO₄²⁻+4H⁺+2e⁻→PbSO₄+2H₂O

During the charge cycle, an electric potential is applied between the positive and negative plates of the battery in such a manner so as to cause electrons to flow into the negative plate, and reverse the electrochemical reactions, as shown below:

Positive Plate:
PbSO₄+2H₂O→PbO₂+SO₄²⁻+4H⁺+2e⁻

Negative Plate:
PbSO₄+2e⁻→Pb⁰+SO₄²⁻

These electrochemical reactions return SO₄²⁻ and hydrogen ions (H⁺) to the electrolyte solution and charge the battery to a state where it is once again ready to supply electrical energy.

It is essential that the voltage applied during the charge cycle be maintained within a specific window in order to facilitate the desired chemical reactions and avoid other electrochemical reactions that reduce the charging efficiency and create unwanted gases. For example, if the potential at the negative electrode during the charge cycle is allowed to increase beyond the value required to facilitate the desired lead-reduction reaction at the negative electrode, the electrons may reach an energy sufficient to reduce H+ dissolved in the electrolyte solution to H₂ (diatomic hydrogen). This reaction is irreversible (i.e., hydrogen ions reduced in this manner cannot be recovered as H+), leads to gassing, a loss of water, and the depletion of hydrogen ions within the electrolyte solution to support the electrochemical reactions. Additionally, energy consumed in hydrogen ion reduction to diatomic hydrogen is wasted, in the sense that it is not being used to generate the desired electrochemical reactions which recharge the battery. This represents inefficient use of the supplied charging energy.

At the same time, if the potential at the positive electrode during the charging cycle is allowed to change beyond the potential required to facilitate the desired chemical reaction at the positive electrode, then the electrons will reach an energy sufficient to break down hydroxide (OH⁻) ions in the electrolyte solution to produce O₂ (diatomic oxygen). This represents a second charging inefficiency, as the energy used to produce the diatomic oxygen is not being used to generate the desired electrochemical reactions necessary to charge the battery.

This latter reaction is reversible in the sense that insoluble diatomic oxygen can be reduced to soluble ions and recombined with hydrogen ions to reconstitute water (H₂O) if it eventually migrates to the negative plate while the charger is still supplying electrons to the cell. This reversible reaction represents yet a third charging inefficiency, however, as the energy used to reduce diatomic oxygen to soluble ions is parasitic in nature, and is not recoverable energy during subsequent discharge cycles. Additionally, the complete conversion of diatomic oxygen created during the charge cycle extends the charge cycle as the movement of diatomic oxygen in the cell space is not influenced by the electric field between the electrodes and must therefore arrive at the charging cathode by random walk.

One measure of battery efficiency is Coulombic Efficiency, which is a measure of the charge applied to the battery during the charging cycle compared to the charge supplied by the battery during the discharge cycle, and is given by:
Coulombic Efficiency=∫I_{discharge}dt/∫I_{charge}dt
where:
I_{discharge}=current provided by the battery during discharge
I_{charge}=current applied to restore the electrodes to a fully charged condition

It is, of course, desirable for the Coulombic Efficiency given by this equation to be equal to 1. However, due to the aforementioned parasitic and undesirable electrochemical reactions and the charging inefficiencies attributable thereto, the charge provided by the battery during discharge will always be less than the charge required to return the electrodes to their fully charged condition. Therefore, due to the aforementioned inefficiencies, the Coulombic Efficiency related to the charge required to restore both electrodes to a full state of charge is always less than 1.

A second measure of battery efficiency is the Energy Efficiency given by:
Energy Efficiency=∫P_{discharge}dt/∫P_{charge}dt
where:
P_{discharge}=Power provided by the battery during discharge
P_{charge}=Power applied to restore the battery electrodes to a fully charged
condition
or, since P=IV
   ∫(I_{discharge})(V_{discharge})dt/∫(I_{charge})(V_{charge})dt
where:
   V₍ₜ₎=Emf₍ₜ₎+I₍ₜ₎R₍ₜ₎
and where:
V₍ₜ₎=instantaneous Voltage
Emf₍ₜ₎=instantaneous actual state of cell charge
I₍ₜ₎=instantaneous current through the cell
R₍ₜ₎=instantaneous internal resistance of the cell

However, the internal resistance of the battery is primarily dependent on the temperature and concentration of the electrolyte. Sulfate ions and hydrogen ions are returned to the electrolyte as the battery is recharged, resulting in a higher concentration of the acid in the aqueous electrolyte solution. As the concentration of the acid in the aqueous solution increases beyond approximately 35%, the resistance of the solution begins to increase rapidly resulting in the need for supplying a higher V₍ₜ₎ to maintain a constant current (I). The voltage of the current delivered during the discharge cycle will always be less that the voltage required to sustain the same current during the charge cycle, ensuring that the total energy efficiency of a charge-discharge cycle will always be less than 1.

As with the Coulombic Efficiency, it is desired that the Energy Efficiency given by the above equations be equal to 1. Again, however, due to the aforementioned inefficiencies, the Energy Efficiency is always less than 1. Otherwise stated, it is impossible to recover all of the energy out of a battery during the discharge cycle that is supplied into the battery during the charge cycle. This is due to the inefficiencies attributable to the unwanted chemical reactions discussed above. In the interest of energy efficiency, it is obviously desirable to minimize the occurrence and/or impact of inefficient chemical reactions. Many energy-storage device designers continue to develop improvements in this regard.

In addition to the conventional inefficiencies discussed above, the present inventors discovered another heretofore unknown source of inefficiency arising from the unique nature of the composite wire disclosed in the '623 patent. As previously discussed, the core material of the composite wire preferably is a multi-fiber core to achieve the tensile strength required to survive the extrusion process and to contribute to the overall structural strength of the battery. FIG. 5 is a cross sectional view of the '623 patent composite wire 51, with a magnified view to show more detail. Individual fibers 52 of the multi-fiber core are surrounded by a lead coating 53 to create the composite wire 51. Due to the construction of the multi-fiber core and the geometry of the individual fibers 52, interstices 54 are formed between the individual fibers 52. As previously disclosed, these composite wires are woven into a grid, coated with an active material and assembled into a battery. After the battery is assembled, it is filled with electrolyte and an initial charging voltage is applied to the battery terminals to convert the positive energy-storage material to PbO₂. During this charging process, the outer surface 55 of the extruded lead coating 53 of the composite wire is also converted into PbO₂.

Due to the construction and geometry of the multi-fiber core, however, acid from the electrolyte penetrates—to a certain axial length—into the interstices 54 between the adjacent fibers 52 and the inner surface of the lead coating 53 via capillary forces. This also causes that portion of the inner surface of lead coating 53 that contacts the electrolyte to be converted into a layer 56 of PbO₂. This conversion of the inner surface is coextensive with the axial point or extent that the acid is able to wick into the multi-fiber core. At that axial point there is a line of demarcation between the converted PbO₂ layer 56 on the inner surface of lead coating 53 and the original, unconverted Pb on the inner surface of lead coating 53. This region forms a miniature battery cell with the PbO₂ layer 56 on the inner surface of the lead coating 53 acting as the positive electrode, and the unconverted Pb on the inner surface of the lead coating 53 acting as the negative electrode, both immersed in electrolyte. This mini-cell undergoes the same processes as the larger parts of the cell during periods of charge, discharge, and open circuit. It does not, however, contribute to the overall capacity of the cell. Since a typical high-performance cell may consist of approximately 540 current-carrying composite wires and there is an equivalent of six such cells in a 12-volt lead-acid battery, the above-described reaction occurs at thousands of separate locations within the battery. Thus, this mini-cell phenomenon can become a significant source of battery inefficiency.

An additional problem is that PbO₂ is an oxidizing agent. Because the PbO₂ layer 56 on the inner surface of lead coating 53 is in direct contact with the remaining Pb of current collector lead coating 53, during periods of open circuit, the current collector lead is not cathodically protected as it is during a discharge cycle in which the negative plate supplies electrons to reduce the PbO₂. Therefore, the Pb of the current collector is continually oxidized by PbO₂ and irreversibly converted into lead oxide (PbO). That is, in the cell, PbO formed on the positive electrode in this manner cannot be recovered as Pb in the current collector. Therefore, under such irreversible chemical oxidation (corrosion), the annular thickness of Pb on the composite wire is continually reduced and leads to an increase in the resistance (R) of the composite wire, which decreases its capacity to carry current. The resistance R is given by:
R=p(L/A)
where:
p=lead conductivity
L=length of the electronic path
A=cross-sectional area of the Pb conductor

As can been seen in the equation above, the resistance of the composite wire is inversely proportional to the area (A) of the Pb coating of the composite wire. Therefore, as Pb is lost due to conversion to PbO, the area of the Pb coating decreases and the resistance of the composite wire, and thus the overall internal resistance of the battery, increases. Effects of this increased resistance appear as higher voltage to push the required current through the cell. Increased power required to store the same quantity of charge in the cell is seen in increased charging temperature and reduced cycle-to-cycle energy efficiency.

It can be seen from the foregoing that the acid wicking problem discovered by the present inventors not only creates inefficiencies within the battery through self-discharge, but also increases the internal resistance of the battery through irreversible corrosion of the current collector thus creating additional energy inefficiencies during the charging and discharging cycles as previously discussed. Accordingly, although the multi-fiber composite wire technology disclosed by the '623 patent and the '878 patent provides a significant improvement in specific power and specific energy over conventional battery technologies and operates at significantly higher Coulombic and Energy efficiency than conventional battery technologies, it subtly introduced other sources of inefficiencies not characteristic of conventional battery designs. It is desirable, therefore, to address the core-material acid absorption problem to eliminate the corrosion and self-discharge mechanisms, and thereby to extend service life and to further improve performance and efficiency of batteries and all energy storage devices which may use the superior performance, composite material current collectors in either bipolar or monopolar configuration.

### SUMMARY OF THE INVENTION

The present invention overcomes various disadvantages of prior art devices by eliminating the corrosion and self-discharge mechanisms associated with the composite wire discussed above, thus extending service life, and by improving performance and efficiency in energy storage devices employing such composite material as current collectors.

In accordance with one exemplary embodiment of the present invention, a current collector for an energy storage device is provided that is woven from a plurality of weft composite wires and a plurality of warp composite wires. Each of the composite wires includes a core and a metal coating formed around the outer surface of the core. The core is comprised of a plurality of longitudinally extending fibers radially arranged to define interstices between outer surfaces of adjacent fibers, and a matrix positioned within the interstices to such an extent that the core is substantially impervious to fluid penetration via capillary forces. The matrix preferably is comprised of a hydrophobic, material that softens and becomes flowable when heated, is resistant to acid corrosion, and is electrically and ionically non-conductive.

In accordance with one embodiment of the invention, the otherwise fibrous core is rendered substantially impervious to acid penetration by the presence of the matrix. Consequently, the drawbacks discussed above with respect to acid wicking into the composite wire can be prevented.

By using a hydrophobic, material for the matrix that softens and becomes flowable during heating, the matrix can be formed among the interstices between fibers during the metal extrusion process used to form the composite wire. Thus, the present invention can be readily incorporated into prior art production methods for producing conventional composite wire.

Another embodiment of the present invention relates to an energy storage device comprised of a case, a plurality of stacked plates positioned in the case and a separator positioned between each adjacent pair of plates. Each plate comprises a current collector formed by a plurality of woven composite wires and active material positioned on the current collector. Again, each core is comprised of a plurality of longitudinally extending fibers radially arranged to define interstices between the outer surfaces of adjacent fibers, and a matrix positioned within the interstices to such an extent that the core is substantially impervious to fluid penetration via capillary forces. The energy storage device is particularly well suited as a lead-acid battery, for example, with an active material positioned on the current collectors and an acid containing electrolyte solution in communication with the plates.

The present invention also relates to a method of making a composite wire by providing a continuous length of fibrous material comprised of a plurality of longitudinally extending fibers radially arranged to define interstices between outer surfaces of adjacent fibers, providing a hydrophobic, thermally flowable material at least around the outer periphery of the fibrous material, and solid-phase extruding a metal coating around the outer periphery of the hydrophobic, thermally flowable material at an elevated temperature and pressure such that the hydrophobic, thermally flowable material softens and flows into the interstices of the fibrous material to an extent sufficient to render the fibrous material substantially impervious to fluid penetration via capillary forces.

The hydrophobic, thermally flowable material preferably is extruded around the outer periphery of the fibrous material, prior to the solid phase extruding step, under elevated temperature and pressure such that a portion of the hydrophobic, thermally flowable material penetrates at least some of the interstices of the fibrous material. It is also preferred that the fibrous material with the extruded hydrophobic, thermally flowable material is at least partially cooled prior to the solid-phase extruding step.

In another embodiment of the above-discussed method, the fibrous material is formed by interweaving a plurality of bundles of fibers and the hydrophobic, thermally flowable material is applied after the bundles of fibers have been interwoven. Alternately, the hydrophobic, thermally flowable material can be applied to the individual bundles of fibers prior to interweaving.

The present invention also relates to an apparatus for making the composite wire. The apparatus comprises (i) a supply mechanism for supplying a continuous length of fibrous material having longitudinally extending fibers radially arranged to define interstices between outer surfaces of adjacent fibers; (ii) a first extrusion die through which the fibrous material passes to receive a coating of heated hydrophobic, thermally flowable material at least on the outer surface of the fibrous material; (iii) a cooling mechanism for solidifying the hydrophobic, thermally flowable material on the fibrous material; and (iv) a second extrusion die through which the coated fibrous material passes to receive an outer coating of heated metal. The heat and pressure provided in the first and second extruders causes the hydrophobic, thermally flowable material to flow and fill the interstices of the fibrous material to an extent sufficient to make the fibrous material substantially impervious to fluid penetration via capillary forces.

Another embodiment of this invention relates to the similar treatment of any non-metallic, high tensile strength substrate used in the construction of energy storage devices, such as lead acid batteries.

### BRIEF DESCRIPTION OF THE DRAWING

For a better understanding of the nature and objects of the invention, reference should be made to the following detailed description of preferred modes of practicing the invention, read in connection with the accompanying drawings, in which:

FIG. 1 is a perspective view of a composite wire of the prior art;

FIG. 2 is a plan view of a current collector made from a composite wire of the prior art;

FIG. 3 is a perspective view of a bipolar current collector made from a composite wire of the prior art;

FIG. 4 is an exploded view of a battery including the bipolar current collector of FIG. 3;

FIG. 5 is a magnified perspective view of a composite wire of the prior art;

FIG. 6 is a cross-sectional view of a composite wire according to one embodiment of the present invention;

FIG. 7 shows one embodiment of the method and apparatus of the present invention;

FIG. 8 shows another embodiment of the method and apparatus of the present invention;

FIG. 9 shows yet another embodiment of the method and apparatus of the present invention;

FIG. 10 shows still another embodiment of the method and apparatus of the present invention;

FIG. 11 shows a woven fibrous mat in accordance with one embodiment of the present invention; and

FIG. 12 shows yet another embodiment of the method and apparatus of the present invention.

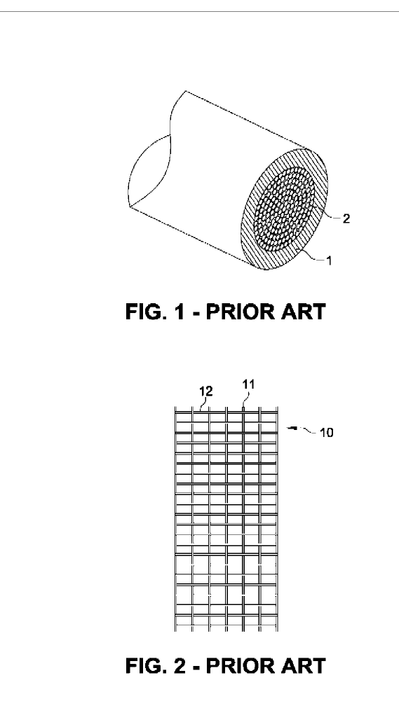

### DETAILED DESCRIPTION OF THE INVENTION

The following description is of exemplary embodiments only and is not intended to limit the scope, applicability, or configuration of the invention in any way. Rather, the following description provides a convenient illustration for implementing exemplary embodiments of the present invention. Various changes to the described embodiments may be made in the function and arrangement of the elements described without departing from the scope of the invention as set forth in the appended claims.

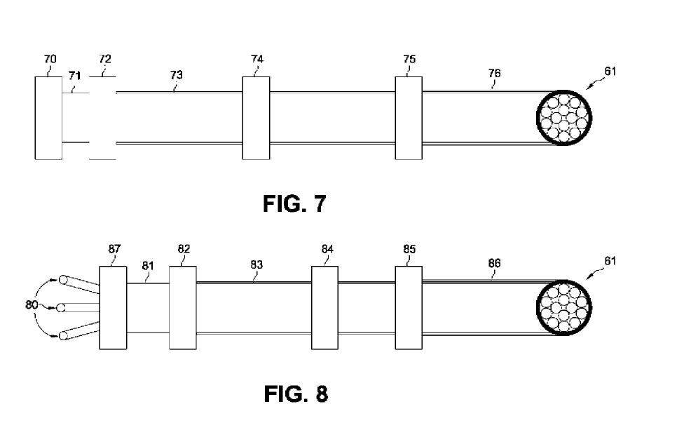

An exemplary embodiment of the present invention is depicted in FIGS. 6 and 7. FIG. 6 shows a rough estimation of the cross-section of the composite wire according to the present invention. A composite wire 61, in accordance with an exemplary embodiment, includes a multi-fiber core 62 with an extruded metal coating 63. The multi-fiber core 62 includes a plurality of longitudinally extending fibers 64 radially arranged to define interstices between outer surfaces of adjacent fibers. The interstices between individual fibers 64 of the multi-fiber core 62 are filled with a matrix 65 to such an extent that the multi-fiber core 62 is substantially impervious to fluid penetration by capillary forces. In the context of a lead-acid battery, the multi-fiber core is substantially impervious to electrolyte penetration to prevent the mini-battery phenomenon discussed above.

The fibers 64 can be made of any material that is of sufficient strength to withstand the extrusion process used to form the metal coating on the outer surface of the multi-fiber core. Suitable materials include, but are not limited to, fibrous materials made of E glass, C glass, carbon, graphite, aramid and combinations thereof.

Suitable fibrous materials may be available in the form of a roving (or bundle), which essentially is a yarn comprised of many fibers. The rovings preferably are from about 0.003 to about 0.008 inches in diameter. More preferably, the rovings are from about 0.004 to about 0.007 inches in diameter. Optimally, the rovings are from about 0.005 to about 0.006 inches in diameter. It should be noted, however, that the rovings may be selected from a wide variety of diameters depending upon the end-diameter of the composite wire to be manufactured. Glass rovings in the range of about 0.005 to about 0.006 inches in diameter can be purchased from Advanced Glass Yarns, Inc., for example. While a single roving could be used for the initial fibrous material of the core, it is preferable to use two or three rovings interwoven together. When three rovings of from about 0.005 to about 0.006 inches in diameter are interwoven together, the diameter of the resulting multi-fiber core before matrix impregnation is approximately from about 0.011 to about 0.012 inches.

The matrix 65 may comprise a hydrophobic material that softens and becomes flowable when heated. Such a thermally flowable material may be any material that softens under heat and pressure such that the material can be made to flow. In addition, it is preferable for the material to also be non-reactive with the electrolyte used in the energy-storage device (e.g., an acid-containing electrolyte in the context of a lead-acid battery). This material must also be both electrically and ionically non-conductive to prevent electrical and chemical “shorts” within the battery. Preferably, the material is hydrophobic such that the matrix tends to repel fluids which may otherwise penetrate the core via capillary forces.

One example of a thermally flowable material with these properties in the context of lead-acid batteries is polyester, as used in, for example, polyester leno. Other suitable materials include certain formulations in the class of materials referred to as hot-melt materials. Such materials achieve their thermally flowing characteristics from blending certain waxes, plastics, and resins into a homogeneous mixture suitable for the purposes of the present invention. One exemplary material is available from Industrial Adhesives, Inc. under the trade name Polytape™, Cortape™, or Pack String®. It should be noted that any thermally flowable material may be used in accordance with the present invention, whether now known or hereinafter developed.

The metal used to form the coating can be any metal that is extrudable and corrosion-resistant, such as, for example, lead, zinc, cadmium, or nickel. Preferably, the metal is formed as an annulus around the fibrous material to a thickness of about 0.001 to about 0.015 inches. More preferably, the thickness is from about 0.003 to about 0.013 inches. Optimally, the thickness is from about 0.004 to about 0.012 inches. Larger annulus thicknesses are easily formed for applications requiring exceptionally long service life under severe environmental or heavy duty-cycle requirements.

FIG. 7 shows one embodiment of a process and apparatus for making the composite wire shown in FIG. 6. A continuous length of fibrous material 71 comprising a plurality of longitudinally extending fibers radially arranged to define interstices between outer surfaces of adjacent fibers is fed, by a supply mechanism 70 under tension, into a first extruder 72 where the thermally flowable material is coated onto the outer surface of the fibrous material 71. Heat and pressure are applied to soften and extrude the thermally flowable material from the first extruder 72 into the interstices between the individual fibers of the fibrous material 71 at a rate commensurate with the production mass flow requirements for the coated material. For example, the thermally flowable material is extruded into the interstices of the fibrous material at a temperature of from about 200° F. to about 400° F. and at a pressure of from about 500 to about 5,000 psi. It is possible that the thermally flowable material could be simply coated on the outer surface of the fibrous material 71 and then forced into the interstices of the fibrous material due to the heat and pressure of the subsequent metal extrusion step, but the former method described above is preferred.

Still referring to FIG. 7, the fibrous material 71 with the thermally flowable material coating 73 exits the first extruder 72 and is rapidly cooled by cooling mechanism 74 to a temperature of from about 65° F. to about 90° F., preferably from about 68° F. to about 86° F. At this point, the thermally flowable material solidifies into a matrix material filling the interstices between the individual fibers of the fibrous material and forms multi-fiber core 62 shown in FIG. 6.

In accordance with an exemplary embodiment shown in FIG. 6, the multi-fiber core 62 is then fed, still under tension, into a second extruder 75 where a metal coating 76 is formed around the outer surface of the multi-fiber core by solid-phase extrusion to thus form the composite wire 61 shown in FIG. 6. The second extruder 75 functions essentially in the same manner as described in the '623 patent. For example, the metal coating 76 is formed by solid-phase extrusion around the core 62 at a temperature of from about 300° F. to about 500° F. and at a pressure of from about 5,000 to about 50,000 psi.

The heat applied by the second extruder 75 during the second extrusion step again softens the thermally flowable material and the pressure applied by the metal flowing out of the second extruder 75 causes the softened thermally flowable material to further flow and more efficiently fill the interstices between individual fibers of the multi-fiber core. As the thermally flowable material cools it again creates matrix 65 that fills the interstices between the individual fibers 64 to create the composite wire 61 shown in FIG. 6. It is optimal to fill 100% of the interstices; however, this is very difficult to achieve in practice. Therefore, it is preferable for the matrix to be present to an extent sufficient to render the core substantially impervious to fluid penetration by capillary forces.

In another embodiment of the method of the present invention as shown in FIG. 8, three rovings (bundles) 80, each comprised of approximately 100 fibers 64, are first interwoven together by a weaving mechanism 87 to create a multiple bundle, fibrous material 81. The fibrous material 81 is fed, under tension, into a first extruder 82 where the thermally flowable material is coated onto the outer surface of the fibrous material 81. As with the first embodiment, heat and pressure are applied by the first extruder 82 to soften and extrude the thermally flowable material into the interstices between the individual fibers of the fibrous material 81.

The fibrous material with the thermally flowable material coating 83 exits the first extruder 82 and is rapidly cooled by a cooling mechanism 84 as disclosed in the first embodiment. At this point, the thermally flowable material solidifies into a matrix material filling the interstices between the individual fibers of the fibrous material and forms the multi-fiber core 62 shown in FIG. 6.

The multi-fiber core 62 is then fed, still under tension, into a second extruder 85 where a metal coating is formed around the outer surface of the multi-fiber core by solid-phase extrusion to thus form the composite wire 61 as shown in FIG. 6. Again, the heat applied by the second extruder 85 during the second extrusion step softens the thermally flowable material. The pressure applied by the metal flowing out of the second extruder 85 causes the softened thermally flowable material to further flow and more efficiently fill the interstices between individual fibers of the multi-fiber core. As the thermally flowable material cools it again creates a matrix 65 that fills the interstices between the individual fibers 64 and rovings 80 to create the composite wire 61 shown in FIG. 6. As in the first exemplary embodiment described herein, it is optimal to fill 100% of the interstices; however, this is very difficult to achieve in practice. Therefore, it is preferable for the matrix to be present to an extent sufficient to render the core substantially impervious to fluid penetration by capillary forces.

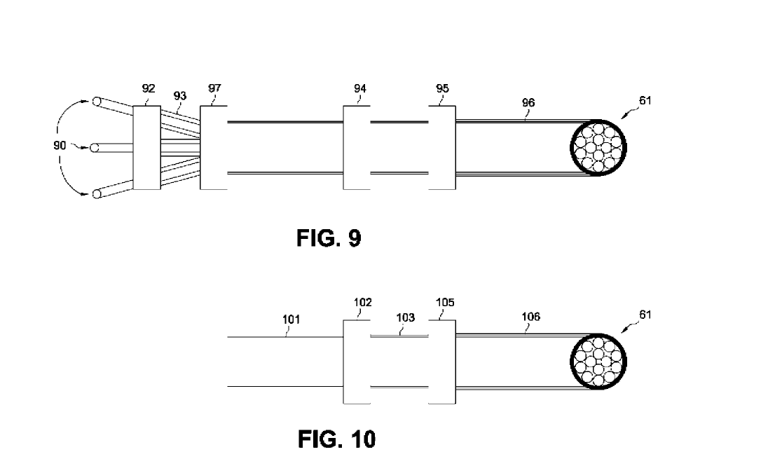

As described above, the fibrous material can be comprised of three rovings, with each roving having approximately 100 individual fibers. Yet another embodiment of the present invention will be described with reference to FIG. 9. Each of the three rovings 90, each comprised of approximately 100 fibers, are fed under tension into a first extruder 92, in which the thermally flowable material is coated onto the outer surface of the rovings 90. As with the previous embodiments, heat and pressure are applied by the first extruder 92 to soften and extrude the thermally flowable material into the interstices between the individual fibers of the rovings 90. The thermally flowable material may be applied to the rovings individually or simultaneously. The rovings with the thermally flowable material 93 exit the first extruder 92 and are interwoven together by a weaving mechanism 97 to create the fibrous material with the thermally flowable material substantially the same as the previous embodiments.

The fibrous material with the thermally flowable coating exits the twisting mechanism 97 and is rapidly cooled by a cooling mechanism 94 as disclosed in the previous embodiments. At this point, the thermally flowable material solidifies into a matrix material filling the interstices between the individual fibers of the fibrous material and forms the multi-fiber core shown in FIG. 6.

The multi-fiber core 62 is then fed, still under tension, into a second extruder 95 where a metal coating is formed around the outer surface of the multi-fiber core by extrusion to thus form the composite wire 61 as shown in FIG. 6. As in the previously described exemplary embodiments, heat applied by the second extruder 95 during the second extrusion step softens the thermally flowable material and the pressure applied by the metal flowing out of the second extruder 95 causes the softened thermally flowable material to further flow and more efficiently fill the interstices between individual fibers of the multi-fiber core. As the thermally flowable material cools it again creates a matrix 65 that fills the interstices between the individual fibers 64 and rovings 80 to create the composite wire 61 shown in FIG. 6.

In another alternative embodiment of the present invention, the cooling step described hereinabove may be omitted. As shown in FIG. 10, the fibrous material 101 is fed under tension into a first extruder 102, in which the thermally flowable material is coated onto the outer surface of the fibrous material 101. As with the previous embodiments, heat and pressure are applied by the first extruder 102 to soften and extrude the thermally flowable material into the interstices between the individual fibers of the fibrous material 101.

The fibrous material with the thermally flowable material coating 103 exits the first extruder 102 and is fed, still under tension, into a second extruder 105 where a metal coating is formed around the outer surface of the fibrous material by extrusion. The heat applied by the second extruder 105 during the second extrusion step further softens the thermally flowable material and the pressure applied by the metal flowing out of the extruder 105 causes the softened thermally flowable material to further flow and more efficiently fill the interstices between individual fibers of the fibrous material. As the thermally flowable material cools it creates a matrix 65 that fills the interstices between the individual fibers 64 to create the composite wire 61 shown in FIG. 6. As in previous exemplary embodiments described herein, it is optimal to fill 100% of the interstices; however, this is very difficult to achieve in practice. Therefore, it is preferable for the matrix to be present to a sufficient extent to render the core substantially impervious to fluid penetration by capillary forces.

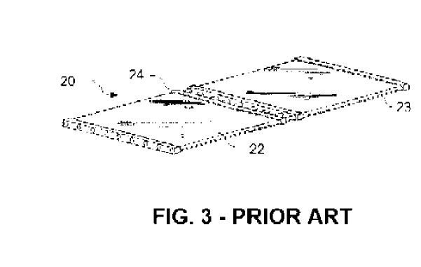

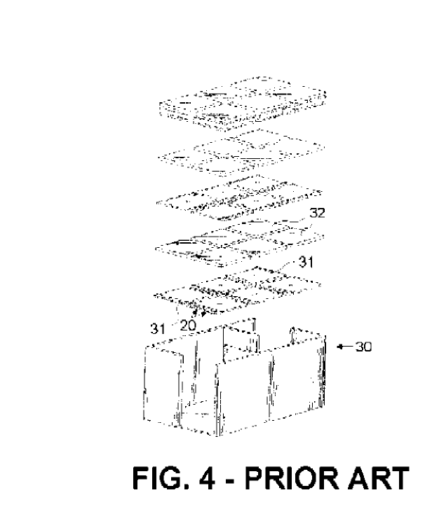

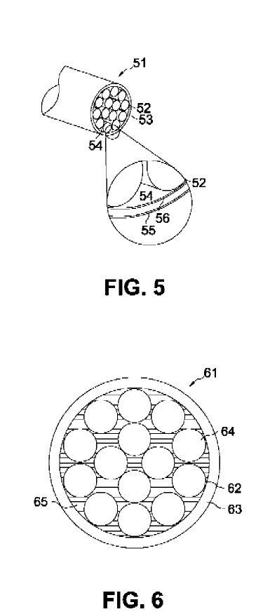

A plurality of weft composite wires and a plurality of warp composite wires made in accordance with any of the methods described above can be woven into a current collector as shown in FIG. 2, for use in making bipolar electrodes as shown in FIG. 3, for manufacturing a battery as shown in FIG. 4. In addition, wires made in accordance with an embodiment of the present invention may be used in manufacturing other types of energy storage devices such as lead-acid capacitors.

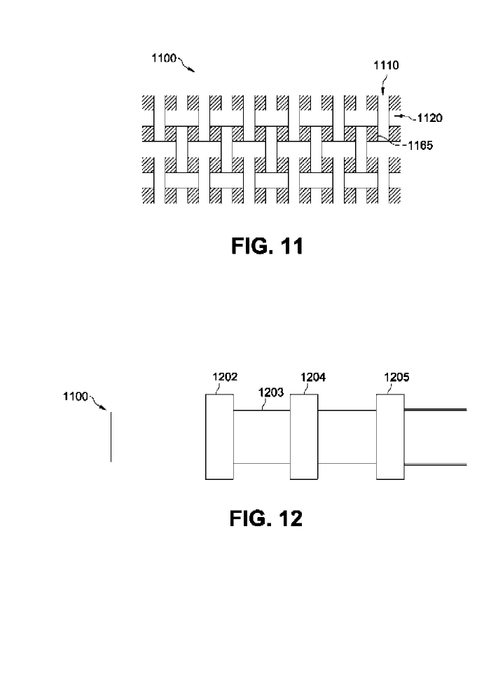

FIG. 11 shows an enlarged view of yet another alternative embodiment of the present invention. A substrate comprising a plurality of longitudinally extending fibers 1101 and latitudinally extending fibers 1102 are woven into a fibrous mat 1100. As shown in FIG. 11, interstices are present between longitudinally extending fibers 1101 and latitudinally extending fibers 1102. A matrix 1165, as described in connection with other exemplary embodiments hereinabove, is positioned within the interstices to such an extent that the woven fibrous mat is substantially impervious to fluid (e.g., acid) penetration via capillary forces. The woven fibrous mat with the matrix positioned within the interstices is coated with a conductive material (not shown) to create a current collector.

Referring now to FIG. 12, a fibrous mat woven from a plurality of longitudinally and latitudinally extending fibers is fed, under tension, into a first extruder 1202, in which a thermally flowable material is coated onto the outer surface of the woven fibrous mat. As with the first embodiment, heat and pressure are applied by the first extruder 1202 to soften and extrude the thermally flowable material into the interstices between the individual fibers of the woven fibrous mat 1100.

The woven fibrous mat with the thermally flowable material coating 1203 exits the first extruder 1202 and is rapidly cooled by a cooling mechanism 1204 as described in more detail hereinabove. The thermally flowable material subsequently solidifies into a matrix material covering the outer surface of the mat, and preferably fills the interstices between the individual fibers of the woven fibrous mat.

The mat is then fed, while still under tension, into a second extruder 1205 where a conductive coating is formed around the outer surface of the woven fibrous mat by solid-phase extrusion. Again, the heat applied by the second extruder 1205 during the second extrusion step softens the thermally flowable material and the pressure applied by the metal flowing out of the second extruder 1205 causes the softened thermally flowable material to further flow and more efficiently fill the interstices between individual fibers of the woven fiber mat. As the thermally flowable material cools it again creates a matrix 1165 that fills the interstices between the individual fibers. As mentioned previously in connection with other exemplary embodiments of the invention, it is optimal to fill 100% of the interstices; however, this is very difficult to achieve in practice. Therefore, it is preferable for the matrix to be present to a sufficient extent to render the core substantially impervious to fluid penetration by capillary forces.

A woven fibrous mat made in accordance with the method described above can be used as a current collector as shown in FIG. 2, for use in making bipolar electrodes as shown in FIG. 3, for manufacturing a battery as shown in FIG. 4. In addition, wires made in accordance with an embodiment of the present invention may be used in manufacturing other types of energy storage devices such as lead-acid capacitors.

It will be understood that various modifications and changes may be made in the present invention by those of ordinary skill in the art who have the benefit of this disclosure. For example the present invention is applicable to a multi-fiber core wherein each individual fiber is coated with a hydrophobic material prior to being combined with other fibers to create the aforementioned roving. Alternatively, the hydrophobic material may be applied by other methods known to those skilled in the art, such as spraying. Additionally, the present invention is applicable to a composite wire manufactured from a monofilament core. Still further, the fibrous mat can take the form of randomly oriented, intertwined fibers (such as a steel wool structure). All such changes and modifications fall within the spirit of this invention, the scope of which is measured by the following appended claims.

1. A current collector for an energy storage device comprising a plurality of composite wires, each of said composite wires comprising:
a core comprising a plurality of longitudinally extending fibers radially arranged to define interstices between outer surfaces of adjacent fibers, and a matrix positioned within said interstices to such an extent that said core is substantially impervious to fluid penetration via capillary forces; and
a metal coating formed around the outer surface of said core.

2. The current collector of claim 1, wherein said plurality of composite wires comprises weft composite wires and warp composite wires woven together.

3. The current collector of claim 1, wherein said matrix comprises a material that softens and becomes flowable when heated.

4. The current collector of claim 3, wherein the material of said matrix is electrically and ionically non-conductive.

5. The current collector of claim 4, wherein the material of said matrix is resistant to acid corrosion.

6. The current collector of claim 1, wherein said matrix comprises polyester.

7. The current collector of claim 1, wherein said metal coating is formed on said core by solid-phase extrusion.

8. The current collector of claim 1, wherein said metal coating comprises a corrosion-resistant metal.

9. The current collector of claim 8, wherein said metal comprises at least one metal selected from the group consisting of lead, zinc, cadmium and nickel.

10. The current collector of claim 1, wherein said fibers comprise a glass material.

11. An energy storage device comprising:
a case;
a plurality of stacked plates positioned in said case; and
a separator positioned between each adjacent pair of plates;
wherein each plate comprises a current collector formed by a plurality of woven composite wires and active material positioned on said current collector, and wherein each of said composite wires comprises
a core comprising a plurality of longitudinally extending fibers radially arranged to define interstices between outer surfaces of adjacent fibers, and a matrix positioned within said interstices to such an extent that said core is substantially impervious to fluid penetration via capillary forces; and
a metal coating formed around the outer surface of said core.

12. The energy storage device of claim 11, wherein said plates are battery plates, and said energy storage device further comprises an electrolyte solution in communication with said plates.

13. The energy storage device of claim 12, wherein said active material comprises at least one of lead and compounds containing lead.

14. The energy storage device of claim 13, wherein said electrolyte solution comprises acid.

15. A lead-acid battery comprising:
a case;
a plurality of stacked battery plates positioned in said case;
a separator positioned between each adjacent pair of battery plates; and
an acid containing electrolyte solution in communication with said battery plates; wherein each battery plate comprises a current collector formed by a plurality of woven composite wires, and active material positioned on said current collector, and wherein each of said composite wires comprises a core and a metal coating formed around the outer surface of said core, said core being substantially impervious to acid penetration via capillary forces.

16. The lead-acid battery of claim 15, wherein said core comprises a plurality of longitudinally extending fibers radially arranged to define interstices between outer surfaces of adjacent fibers, and a matrix positioned within said interstices to such an extent that said core is substantially impervious to acid penetration via capillary forces.

17. The lead-acid battery of claim 15, wherein said metal coating is formed on said core by solid-phase extrusion.

18. The lead-acid battery of claim 15, wherein said metal coating comprises a corrosion-resistant metal.

19. A composite wire comprising:
a core comprising a plurality of longitudinally extending fibers radially arranged to define interstices between outer surfaces of adjacent fibers, and
a matrix positioned within said interstices to such an extent that said core is substantially impervious to fluid penetration via capillary forces; and
a metal coating formed around the outer surface of said core.

20. The composite wire of claim 19, wherein said matrix comprises a material that softens and becomes flowable when heated.

21. The composite wire of claim 20, wherein the material of said matrix is electrically and ionically non-conductive.

22. The composite wire of claim 21, wherein the material of said matrix is resistant to acid corrosion.

23. The composite wire of claim 19, wherein said matrix comprises polyester.

24. The composite wire of claim 19, wherein said metal coating is formed on said core by solid-phase extrusion.

25. The composite wire of claim 19, wherein said metal coating comprises a corrosion-resistant metal.

26. The composite wire of claim 25, wherein said metal comprises at least one metal selected from the group consisting of lead, zinc, cadmium and nickel.

27. The composite wire of claim 19, wherein said fibers comprise a glass material.
